(19) United States
(12) Patent Application Publication
(10) Pub. No.: US 2002/0108482 A1
(43) Pub. Date: Aug. 15, 2002

(54) Perforating punch

(75) Inventor: Yoshihisa Negishi, Minamiashigara-shi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/124,325

(22) Filed: Apr. 18, 2002

Related U.S. Application Data
(62) Division of application No. 09/312,478, filed on May 17, 1999.

(30) Foreign Application Priority Data
May 22, 1998 (JP) 10-141831

(51) Int. Cl. B26F 1/14

(52) U.S. Cl. 83/689; 83/684

(57) ABSTRACT

A perforating punch has first, second, third, and fourth tips, a first diagonal ridge contiguous to the first and second tips, a second diagonal ridge contiguous to the third and fourth tips, and an included angle setting point located at the point of intersection between the first and second diagonal ridges and positioned longitudinally of the perforating punch to bend the first and second diagonal ridges for thereby establishing included angles at the first, second, third, and fourth tips. The perforating punch allows an included angle and a shear angle thereof to be established independently for each of the four sides of a rectangular perforation to be produced, and is capable of establishing cutting conditions easily in a wide range.

### BACKGROUND OF THE INVENTION

1. Field of the Invention

The present invention relates to a perforating punch for forming a rectangular perforation in a workpiece.

2. Description of the Related Art

Various perforating punches have been used in the art for forming perforations in sheet-like workpieces such as photographic films. The perforating punches are designed to produce perforations of standardized rectangular shapes. Efforts have been made to shape the cutting edges of the perforating punches to special configurations in order to produce high-quality perforations in photographic films.

For example, FIG. 13A of the accompanying drawings shows a perforating punch 1 of the round edge type having a lower end cut off to an arcuate concave shape providing a lower concave curved surface 2. Another perforating punch 3 shown in FIG. 13B of the accompanying drawings is of the slant edge type having a lower end cut off to a slant shape providing a lower slant surface 4 which lies perpendicularly to opposite parallel sides of the punch 3 and obliquely to other opposite parallel sides of the punch 3. According to another perforating punch design shown in FIG. 13C of the accompanying drawings, a perforating punch 5 is of the diagonal slant edge type having a lower end cut off to a diagonal slant shape providing a lower diagonal slant surface 6 which lies obliquely to all sides of the punch 5.

However, the perforating punches 1, 3, 5 allow good perforating conditions only for one or two of the four sides of rectangular perforations to be produced. Another problem of the perforating punches 1, 3, 5 is that an included angle and a shear angle thereof for determining cutting conditions for the sides of rectangular perforations to be produced cannot be established independently depending only sheet-like workpieces such as photographic films to be perforated.

### SUMMARY OF THE INVENTION

It is a principal object of the present invention to provide a perforating punch which allows an included angle and a shear angle thereof to be established independently for each of the sides of a rectangular perforation to be produced, and which is capable of establishing cutting conditions optimum for various sheet-like workpieces to be perforated.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a fragmentary perspective view of a perforating punch according to a first embodiment of the present invention;

FIG. 2 is a fragmentary perspective view of the perforating punch shown in FIG. 1;

FIG. 3 is a fragmentary side elevational view illustrating a shear angle of the perforating punch shown in FIG. 1;

FIG. 4 is a fragmentary side elevational view illustrating an included angle of the perforating punch shown in FIG. 1;

FIG. 5 is a fragmentary perspective view of a perforating punch according to a second embodiment of the present invention;

FIG. 6 is a fragmentary perspective view of a perforating punch according to a third embodiment of the present invention;

FIG. 7 is a fragmentary perspective view of a perforating punch according to a fourth embodiment of the present invention;

FIG. 8 is a fragmentary side elevational view of the perforating punch shown in FIG. 7;

FIG. 9 is a fragmentary perspective view of a perforating punch according to a fifth embodiment of the present invention;

FIG. 10 is a fragmentary side elevational view of the perforating punch shown in FIG. 9;

FIG. 11 is a fragmentary perspective view of a perforating punch according to a sixth embodiment of the present invention;

FIG. 12 is a fragmentary perspective view of a perforating punch according to a seventh embodiment of the present invention;

FIG. 13A is a fragmentary perspective view of a conventional perforating punch of the round edge type;

FIG. 13B is a fragmentary perspective view of a conventional perforating punch of the slant edge type;. and

FIG. 13C is a fragmentary perspective view of a conventional perforating punch of the diagonal slant edge type.

### DESCRIPTION OF THE PREFERRED EMBODIMENTS

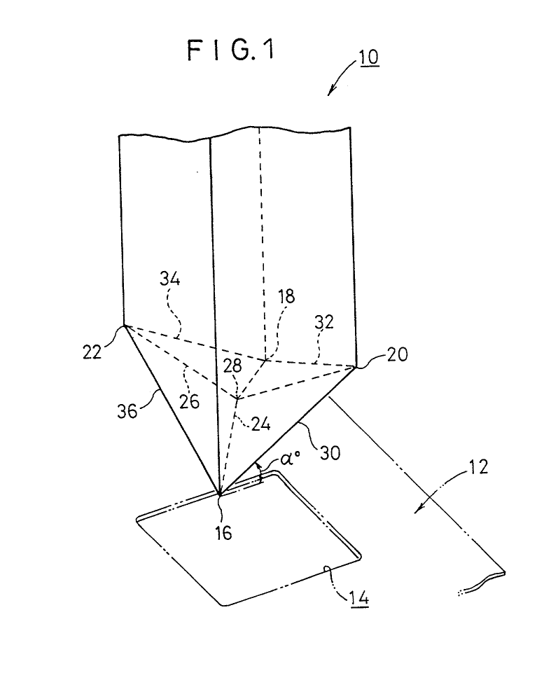

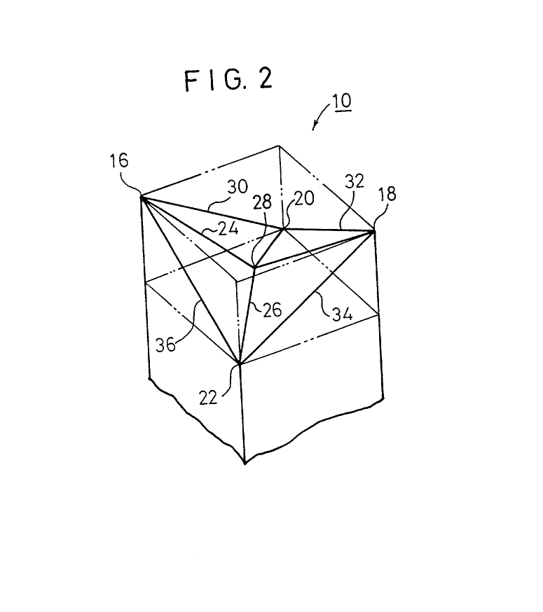

FIGS. 1 and 2 show in fragmentary perspective a perforating punch 10 according to a first embodiment of the present invention. The perforating punch 10 is used to form a rectangular perforation 14 in a sheet-like workpiece such as a photograph film 12, for example.

As shown in FIGS. 1 through 4, the perforating punch 10 has a shank of a rectangular cross-sectional shape, and includes first and second tips 16, 18 located respectively at diagonally spaced positions corresponding to two of the four corners of the rectangular cross-sectional shape, third and fourth tips 20, 22 located respectively at diagonally spaced positions corresponding to the other two of the four corners of the rectangular cross-sectional shape, a first diagonal ridge 24 contiguous to the first and second tips 16, 18, a second diagonal ridge 26 contiguous to the third and fourth tips 20, 22, and an included angle setting point 28 located at the point of intersection between the first and second diagonal ridges 24, 26 and positioned longitudinally of the perforating punch 10 to bend the first and second diagonal ridges 24, 26 for thereby establishing included angles at the first, second, third, and fourth tips 16, 18, 20, 22.

The first and second tips 16, 18 project toward the photographic film 12 in the longitudinal direction of the perforating punch 10, and the third and fourth tips 20, 22 are spaced from the first and second tips 16, 18 in a direction away from the photographic film 12 in the longitudinal direction of the perforating punch 10. The perforating punch 10 also has a first side ridge 30 contiguous to the first and third tips 16, 20, a second side ridge 32 contiguous to the third and second tips 20, 18, a third side ridge 34 contiguous to the second and fourth tips 18, 22, and a fourth side ridge 36 contiguous to the fourth and first tips 22, 16. The first, second, third, and fourth side ridges 30, 32, 34, 36 correspond respectively to the four sides of the rectangular cross-sectional shape of the perforating punch 10.

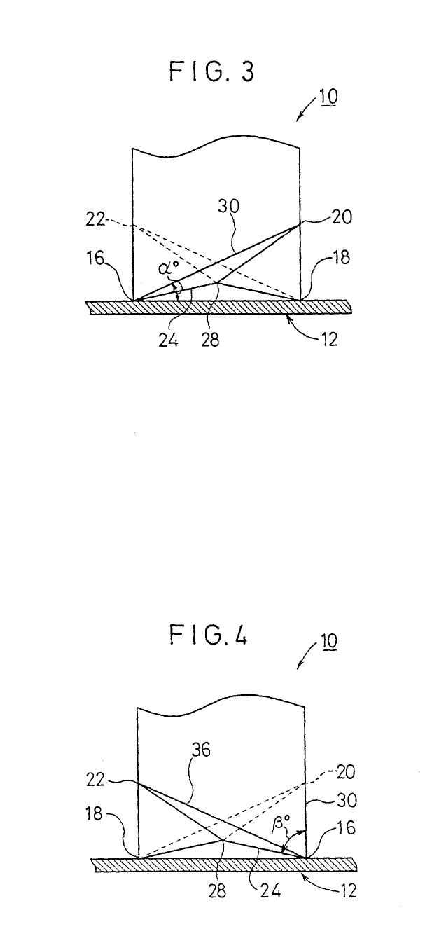

As shown in FIG. 3, shear angles α° of the first, second, third, and fourth side ridges 30, 32, 34, 36 are set to desired angles by positioning the third and fourth tips 20, 22 depending on the positions of the first and second tips 16, 18 in the longitudinal direction of the perforating punch 10. As shown in FIG. 4, the position of the included angle setting point 28 in the longitudinal direction of the perforating punch 10 is determined depending on the positions of the first, second, third, and fourth tips 16, 18, 20, 22 in the longitudinal direction of the perforating punch 10, for thereby setting included angles β° of the first, second, third, and fourth side ridges 30, 32, 34, 36 to desired angles. The shear angle α° represents an angle at which the workpiece is sandwiched between upper and lower cutting edges. The included angle β° represents a cutting edge angle projected onto a plane perpendicular to a line to be cut.

When the perforating punch 10 moves downwardly toward the photographic film 12, the first and second tips 16, 18 are brought into contact with the photographic film 12.

When the perforating punch 10 further descends, the first and second tips 16, 18 are forced into the photographic film 12 at respective diagonal positions of the perforation 14, and the first, second, third, and fourth side ridges 30, 32, 34, 36 cut off the photographic film 12 along respective sides of the perforation 14. When the third and fourth tips 20, 22 reach the photographic film 12, the perforation 14 is formed in the photographic film 12 by the perforating punch 10.

According to the first embodiment, as described above, the shear angles α° of the first, second, third, and fourth side ridges 30, 32, 34, 36 are set to desired angles by positioning the third and fourth tips 20, 22 depending on the positions of the first and second tips 16, 18 in the longitudinal direction of the perforating punch 10. Furthermore, the position of the included angle setting point 28 in the longitudinal direction of the perforating punch 10 is determined depending on the positions of the first, second, third, and fourth tips 16, 18, 20, 22 in the longitudinal direction of the perforating punch 10, for thereby setting the included angles β° of the first, second, third, and fourth side ridges 30, 32, 34, 36 to desired angles.

Consequently, all the shear angles α° and included angles β° of the first, second, third, and fourth side ridges 30, 32, 34, 36 can be set to desired angles. The perforating punch 10 can thus form desired perforations 14 highly efficiently and accurately in various photographic films 12 regardless of the differences between materials, for example, of those photographic films 12.

The shear angles α° and included angles β° of the first, second, third, and fourth side ridges 30, 32, 34, 36 can easily be set to a wide range of desired angles simply by determining the positions of the third and fourth tips 20, 22 in the longitudinal direction of the perforating punch 10 and determining the position of the included angle setting point 28 in the longitudinal direction of the perforating punch 10. The perforating punch 10 is thus highly versatile in use. For example, the perforating punch 10 can reliably produce the perforation 14 with high-quality sides in an APS film, for example, without producing emulsion layer debris and peelings, base layer whiskers, and other unwanted defects.

The perforating punch 10 can also be used to form rectangular holes in other thin planar workpieces.

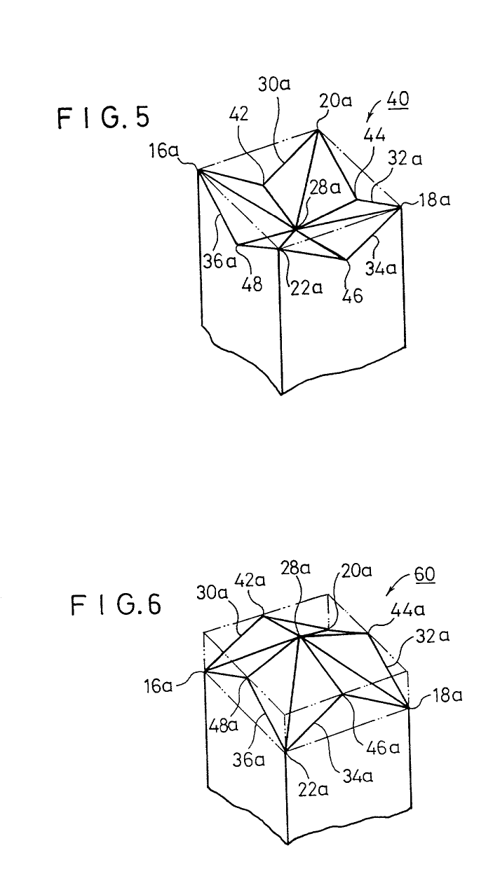

FIG. 5 shows in fragmentary perspective a perforating punch 40 according to a second embodiment of the present invention. Those parts of the perforating punch 40 which are identical to those of the perforating punch 10 according to the first embodiment are denoted by identical reference characters with a suffix “a”, and will not be described in detail below.

The perforating punch 40 has first, second, third, and fourth tips 16a, 18a, 20a, 22a located in the same positions in the longitudinal direction of the perforating punch 40. The perforating punch 40 has a first shear angle setting point 42 positioned longitudinally of the perforating punch 40 to bend a first side ridge 30a for thereby establishing a shear angle of the first side ridge 30a, a second shear angle setting point 44 positioned longitudinally of the perforating punch 40 to bend a second side ridge 32a for thereby establishing a shear angle of the second side ridge 32a, a third shear angle setting point 46 positioned longitudinally of the perforating punch 40 to bend a third side ridge 34a for thereby establishing a shear angle of the third side ridge 34a, and a fourth shear angle setting point 48 positioned longitudinally of the perforating punch 40 to bend a fourth side ridge 36a for thereby establishing a shear angle of the fourth side ridge 36a.

When the perforating punch 40 moves downwardly toward the photographic film, the first, second, third, and fourth tips 16a, 18a, 20a, 22a are substantially simultaneously brought into contact with the photographic film 12. While holding the photographic film 12 with the first, second, third, and fourth tips 16a, 18a, 20a, 22a, the perforating punch 40 forms a perforation 14 in the photographic film 12.

According to the second embodiment, since the first, second, third, and fourth tips 16a, 18a, 20a, 22a are substantially simultaneously brought into contact with the photographic film 12, the perforating punch 40 can hold the photographic film 12 stably with the four points, i.e., the first, second, third, and fourth tips 16a, 18a, 20a, 22a. Therefore, the perforating punch 40 can form the perforation 14 more reliably and accurately in the photographic film 12.

The first, second, third, and fourth shear angle setting points 42, 44, 46, 48 are positioned as bending points respectively on the first, second, third, and fourth side ridges 30a, 32a, 34a, 36a, so that the distance which the perforating punch 40 needs to traverse across the photographic film 12 to form the perforation 14 can be reduced to one half of the distance which the perforating punch 10 according to the first embodiment needs to traverse across the photographic film 12 to form the perforation 14. Therefore, the stroke of an actuator (not shown) for moving the perforating punch 40 toward and away from the photographic film 12 is reduced to one half, and hence the perforating punch 40 can form the perforation 14 efficiently within a shortened period of time.

On the perforating punch 40, the first, second, third, and fourth shear angle setting points 42, 44, 46, 48 are spaced from the first, second, third, and fourth tips 16a, 18a, 20a, 22a in a direction away from the photographic film 12 in the longitudinal direction of the perforating punch 40.

FIG. 6 shows in fragmentary perspective a perforating punch 60 according to a third embodiment of the present invention. As shown in FIG. 6, the perforating punch 60 has first, second, third, and fourth shear angle setting points 42a, 44a, 46a, 48a which are spaced from the first, second, third, and fourth tips 16a, 18a, 20a, 22a in a direction toward the photographic film 12 in the longitudinal direction of the perforating punch 60.

When the perforating punch 60 moves downwardly toward the photographic film, the first, second, third, and fourth shear angle setting points 42a, 44a, 46a, 48a are substantially simultaneously brought into contact with the photographic film 12. While holding the photographic film 12 with the first, second, third, and fourth shear angle setting points 42a, 44a, 46a, 48a, the perforating punch 60 forms a perforation 14 in the photographic film 12. Therefore, the perforating punch 60 offers the same advantages as those of the perforating punch 40 according to the second embodiment.

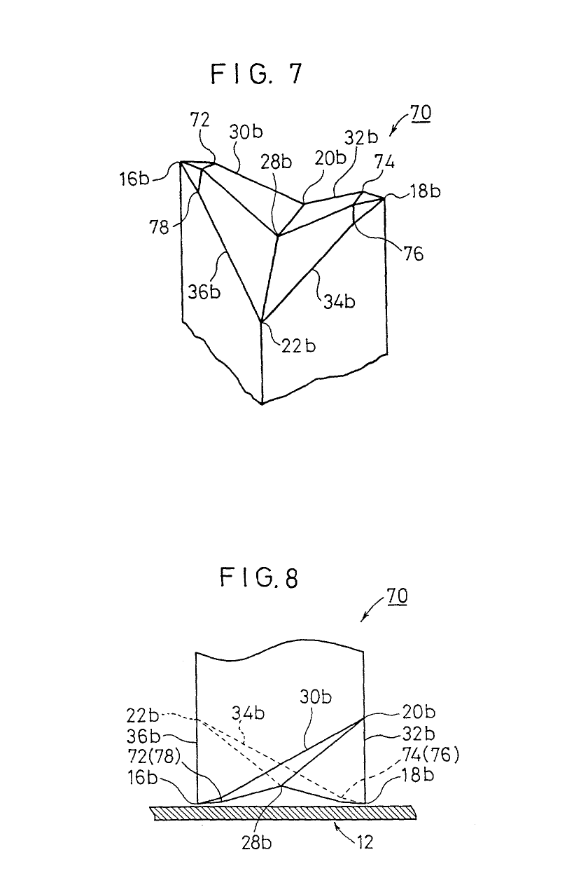

FIG. 7 shows in fragmentary perspective a perforating punch 70 according to a fourth embodiment of the present invention. Those parts of the perforating punch 70 which are identical to those of the perforating punch 10 according to the first embodiment are denoted by identical reference characters with a suffix “b”, and will not be described in detail below.

The perforating punch 70 has first and second tips 16b, 18b projecting a greater distance toward the photographic film 12 than third and fourth tips 20b, 22b. The perforating punch 70 also has a first shear angle setting pint 72 on a first side ridge 30b for bending the first ridge 30b in a direction to reduce a shear angle at the first tip 16b, as shown in FIG. 8. Similarly, the perforating punch 70 also has second, third, and fourth shear angle setting points 74, 76, 78 respectively on second, third, and fourth side ridges 32b, 34b, 36b for bending the second, third, and fourth side ridges 32b, 34b, 36b in a direction to reduce shear angles at the second tip 18b and the first tip 16b.

According to the fourth embodiment, as described above, the first, second, third, and fourth shear angle setting points 72, 74, 76, 78 are provided in order to reduce the shear angles at the first and second tips 16b, 18b. Therefore, the first and second tips 16b, 18b do not have highly sharp edges. The perforating punch 70 is thus reliably effective to prevent the first and second tips 16b, 18b from being broken or rapidly worn, and can be used highly accurately and stably for a long period of time.

FIG. 9 shows in fragmentary perspective a perforating punch 80 according to a fifth embodiment of the present invention. Those parts of the perforating punch 80 which are identical to those of the perforating punch 10 according to the first embodiment are denoted by identical reference characters with a suffix “c”, and will not be described in detail below.

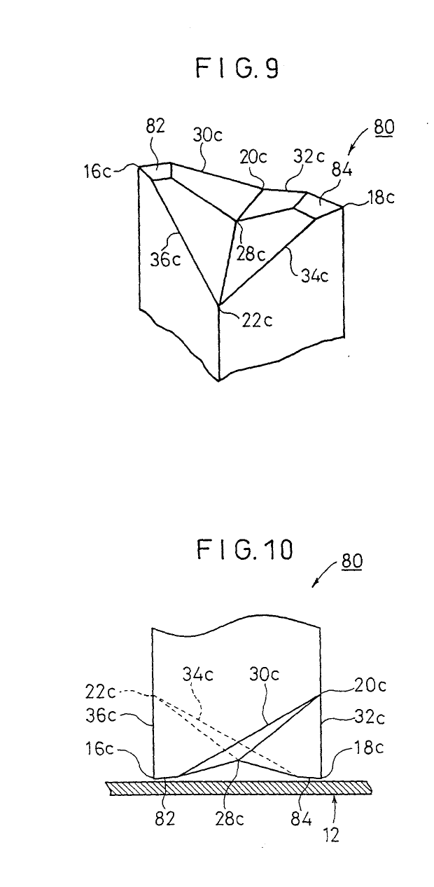

The perforating punch 80 has flat facets 82, 84 disposed respectively at first and second tips 16c, 18c. The flat facets 82, 84 may be formed by cutting off the perforating punch 80 into flat or V-shaped facets as viewed diagonally from a side of the perforating punch 80 (see FIG. 10) .

According to the fifth embodiment, the first and second tips 16c, 18c are prevented from having an acute angle. Therefore, the perforating punch 80 offers the same advantages as those of the perforating punch 70 according to the fourth embodiment.

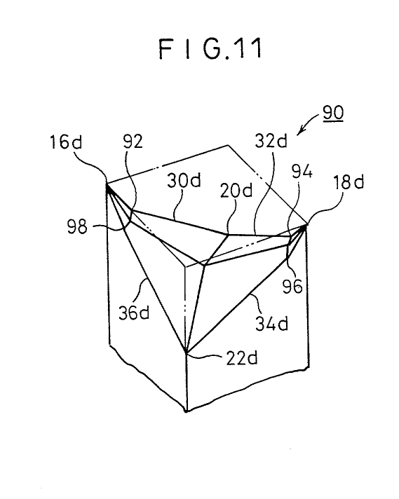

FIG. 11 shows in fragmentary perspective a perforating punch 90 according to a sixth embodiment of the present invention. Those parts of the perforating punch 90 which are identical to those of the perforating punch 10 according to the first embodiment are denoted by identical reference characters with a suffix “d”, and will not be described in detail below.

The perforating punch 90 has first and second tips 16d, 18d projecting a greater distance toward the photographic film 12 than third and fourth tips 20d, 22d. The perforating punch 90 also has a first shear angle setting pint 92 on a first side ridge 30d for bending the first side ridge 30d in a direction to increase a shear angle at the first tip 16d. Similarly, the perforating punch 90 also has second, third, and fourth shear angle setting points 94, 96, 98 respectively on second, third, and fourth side ridges 32d, 34d, 36d for bending the second, third, and fourth side ridges 32d, 34d, 36d in a direction to increase shear angles at the second tip 18d and the first tip 16d.

According to the sixth embodiment, as described above, the first, second, third, and fourth shear angle setting points 92, 94, 96, 98 are provided in order to increase the shear angles at the first and second tips 16d, 18d. Therefore, the first and second tips 16d, 18d provide sharp edges for making the perforating punch 90 effective to form the perforation 14 with clearer sides.

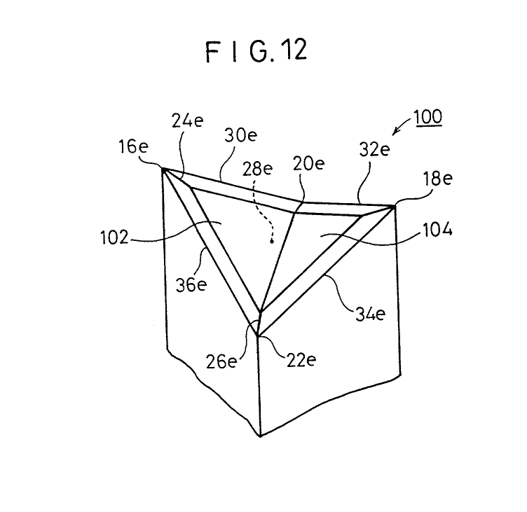

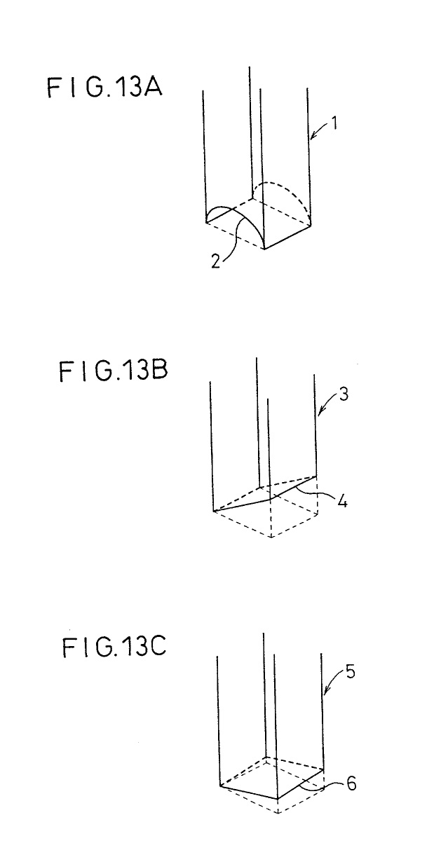

FIG. 12 shows in fragmentary perspective a perforating punch 100 according to a seventh embodiment of the present invention. Those parts of the perforating punch 100 which are identical to those of the perforating punch 10 according to the first embodiment are denoted by identical reference characters with a suffix “e”, and will not be described in detail below.

The perforating punch 100 has flat facets 102, 104 by cutting off a convex region including an included angle setting point 28e. The flat facets 102, 104 may be arranged so as to lie parallel to first and second side ridges 30e, 32e as viewed diagonally from a side of the perforating punch 100 with a third tip 20e positioned centrally. The flat facets 102, 104 may be replaced with circular or rectangular spot-faced surfaces.

When the perforating punch 100 moves downwardly toward the photographic film, the first and second tips 16e, 18e are brought into contact with the photographic film. When the perforating punch 100 further descends, the first, second, third, and fourth side ridges 30e, 32e, 34e, 36e cut off the photographic film.

According to the seventh embodiment, the perforating punch 100 has the flat facets 102, 104 which are formed by cutting off the convex region including the included angle setting point 28e. Therefore, a first diagonal ridge 24e is shortened, and does not excessively pull in the photographic film when it contacts the photographic film after the first and second tips 16e, 18e have reached the photographic film. As a result, the perforation that is formed by the perforating punch 100 is effectively prevented from having an undesired defective shape or damaged sides.

The perforating punch 100 is constructed on the basis of the perforating punch 10 according to the first embodiment. However, the perforating punch 100 may be constructed on the basis of either one of the perforating punches 40, 60, 70, 80, 90 according to the second, third, fourth, fifth, and sixth embodiments.

According to the present invention, the perforating punch has an included angle setting point disposed at the point of intersection between a first diagonal ridge contiguous to first and second tips at a pair of diagonal positions and a second diagonal ridge contiguous to third and fourth tips at another pair of diagonal positions. The position of the included angle setting point in the longitudinal direction of the perforating punch is established to bend the first and second diagonal ridges to set included angles at the first through fourth tips to desired angles. Consequently, it is possible to set angle conditions of the first through fourth tips to appropriate conditions. The perforating punch can be fabricated so as to be optimum for various different workpieces to be perforated.

Although certain preferred embodiments of the present invention have been shown and described in detail, it should be understood that various changes and modifications may be made therein without departing from the scope of the appended claims.

What is claimed is:

1. A perforating punch for forming a rectangular perforation in a workpiece, comprising:
a shank of a rectangular cross-sectional shape;
first and second tips located respectively at diagonally spaced positions corresponding to two of the four corners of the rectangular cross-sectional shape;
third and fourth diagonally spaced tips located respectively at diagonally spaced positions corresponding to two of the four corners of the rectangular cross-sectional shape;
a first diagonal ridge contiguous to said first and second tips;
a second diagonal ridge contiguous to said third and fourth tips; and
an included angle setting point located at the point of intersection between said first and second diagonal ridges and positioned longitudinally of said shank to bend said first and second diagonal ridges for thereby establishing included angles at said first, second, third, and fourth tips.

2. A perforating punch according to claim 1, wherein said first, second, third, and fourth tips are disposed the same position longitudinally of said shank, further comprising:
a first shear angle setting point bending a first side ridge contiguous to said first and third tips, to establish a shear angle;
a second shear angle setting point bending a second side ridge contiguous to said third and second tips to establish a shear angle;
a third shear angle setting point bending a third side ridge contiguous to said second and fourth tips to establish a shear angle; and
a fourth shear angle setting point bending a fourth side ridge contiguous to said fourth and first tips to establish a shear angle.

3. A perforating punch according to claim 2, wherein said first, second, third, and fourth shear angle setting points are spaced from said first, second, third, and fourth tips in a direction away from said workpiece.

4. A perforating punch according to claim 2, wherein said first, second, third, and fourth shear angle setting points are spaced from said first, second, third, and fourth tips in a direction toward said workpiece.

5. A perforating punch according to claim 1, wherein said third and fourth tips are spaced from said first and second tips in a direction away from said workpiece.

6. A perforating punch according to claim 5, further comprising:
a first shear angle setting point disposed on said first side ridge contiguous to said first and third tips for bending the first side ridge in a direction to reduce a shear angle at the first tip;
a second shear angle setting point disposed on said second side ridge contiguous to said third and second tips for bending the second side ridge in a direction to reduce a shear angle at the second tip;
a third shear angle setting point disposed on said third side ridge contiguous to said second and fourth tips for bending the third side ridge in a direction to reduce a shear angle at the second tip; and
a fourth shear angle setting point disposed on said fourth side ridge contiguous to said fourth and first tips for bending the fourth side ridge in a direction to reduce a shear angle at the first tip.

7. A perforating punch according to claim 5, further comprising:
a first shear angle setting point disposed on said first side ridge contiguous to said first and third tips for bending the first side ridge in a direction to increase a shear angle at the first tip;
a second shear angle setting point disposed on said second side ridge contiguous to said third and second tips for bending the second side ridge in a direction to increase a shear angle at the second tip;
a third shear angle setting point disposed on said third side ridge contiguous to said second and fourth tips for bending the third side ridge in a direction to increase a shear angle at the second tip; and
a fourth shear angle setting point disposed on said fourth side ridge contiguous to said fourth and first tips for bending the fourth side ridge in a direction to increase a shear angle at the first tip.

8. A perforating punch according to claim 5, wherein said first and second tips have cut-off facets.

9. A perforating punch according to claim 1, further comprising flat facets formed by cutting off a convex portion including said shear angle setting point which is spaced from said first and second tips or said third and fourth tips in a direction toward said workpiece.

10. A perforating punch according to claim 1, further comprising flat facets formed by cutting off a convex portion including said shear angle setting point which is spaced from said first and second tips and said third and fourth tips in a direction toward said workpiece.
